(19) United States
(12) Patent Application Publication
(10) Pub. No.: US 2012/0106900 A1
(43) Pub. Date: May 3, 2012

(54) FIBER ASSEMBLY

(75) Inventors: LI-SHING HOU, New Taipei (TW); HSIEN-CHU LIN, New Taipei (TW)

(73) Assignee: HON HAI PRECISION INDUSTRY CO., LTD., New Taipei (TW)

(21) Appl. No.: 13/284,949

(22) Filed: Oct. 30, 2011

(30) Foreign Application Priority Data
Oct. 29, 2010 (TW) 099220893

(51) Int. Cl. G02B 6/36

(52) U.S. Cl. 385/83; 385/78

(57) ABSTRACT

A fiber assembly (1000) includes at least one fiber (300) including a horizontal section (32) extending along a front-to-back direction, a vertical section (30) extending along a up-to-down direction and a mediate section (31) connecting with the horizontal section and the vertical section; a housing (1) including a first housing piece (10) and a second housing piece (12) combined together to form a substantial ninety degrees arc shape positioning passage (120) therebetween to receive the mediate section (31), under the condition that the horizontal section and the vertical section are disposed perpendicular to each other.

### FIELD OF THE INVENTION

The present invention generally relates to a fiber assembly, and more particularly to a fiber assembly with an improved connecting interface which can change optical signal transmitting path.

### DESCRIPTION OF PRIOR ART

Optical signal transmitting is widely adopted for internet or intranet communication. A fiber assembly is an important physical link for connecting two devices so as to establish the optical signal transmitting path therebetween.

U.S. Pat. No. 6,485,192 issued on Nov. 26, 2002 to Plotts et al. discloses a common fiber assembly which includes a first fiber assembly and a second fiber assembly. The first fiber assembly includes a plurality of fibers connected to a first housing to form a first optical termination. The second fiber assembly includes a plurality of fibers connected to a second housing to form a second optical termination. As both the first optical termination and the second optical termination are straight type and the fibers are too flexible to be deformed, thus the optical signal is only transmitted along a front-to-back direction or a straight line. However, sometimes, the optical signal transmitting path should be changed, i.e., from front-to-back direction to up-to-down direction, and the aforementioned design can not meet such requirement.

Hence, an improved fiber assembly is highly desired to overcome the aforementioned problems.

### SUMMARY OF THE INVENTION

Accordingly, an object of the present invention is to provide a fiber assembly having an improved connecting interface which can change optical signal transmitting direction.

In order to achieve the object set forth, a fiber assembly in accordance with the present invention comprises at least one fiber including a horizontal section extending along a front-to-back direction, a vertical section extending along a up-to-down direction and a mediate section connecting with the horizontal section and the vertical section; a housing including a first housing piece and a second housing piece combined together to form a substantial ninety degrees arc shape positioning passage therebetween to receive the mediate section, under the condition that the horizontal section and the vertical section are disposed perpendicular to each other.

Other objects, advantages and novel features of the invention will become more apparent from the following detailed description when taken in conjunction with the accompanying drawings.

### BRIEF DESCRIPTION OF THE DRAWINGS

FIG. 1 is a partially exploded view of a fiber assembly in accordance with the present invention;

FIG. 2 is similar to FIG. 1, but viewed from other aspect;

FIG. 3 is an assembled, perspective view of the fiber assembly; and

FIG. 4 is a cross-section view of FIG. 3 taken along line 4-4.

### DETAILED DESCRIPTION OF PREFERRED EMBODIMENTS

Reference will now be made in detail to the preferred embodiment of the present invention.

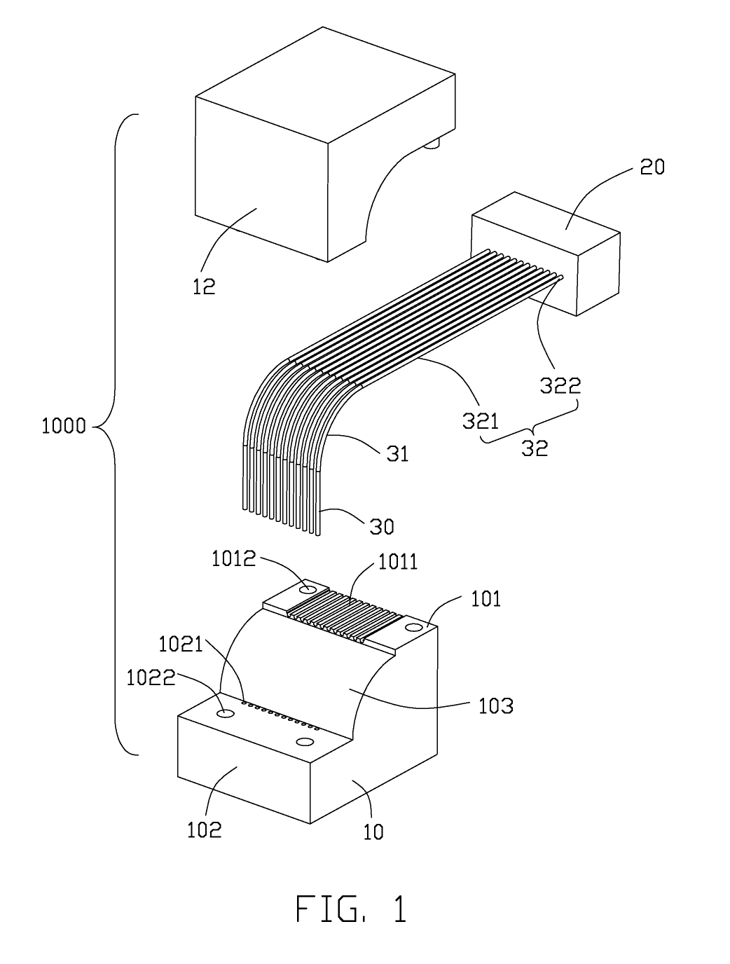

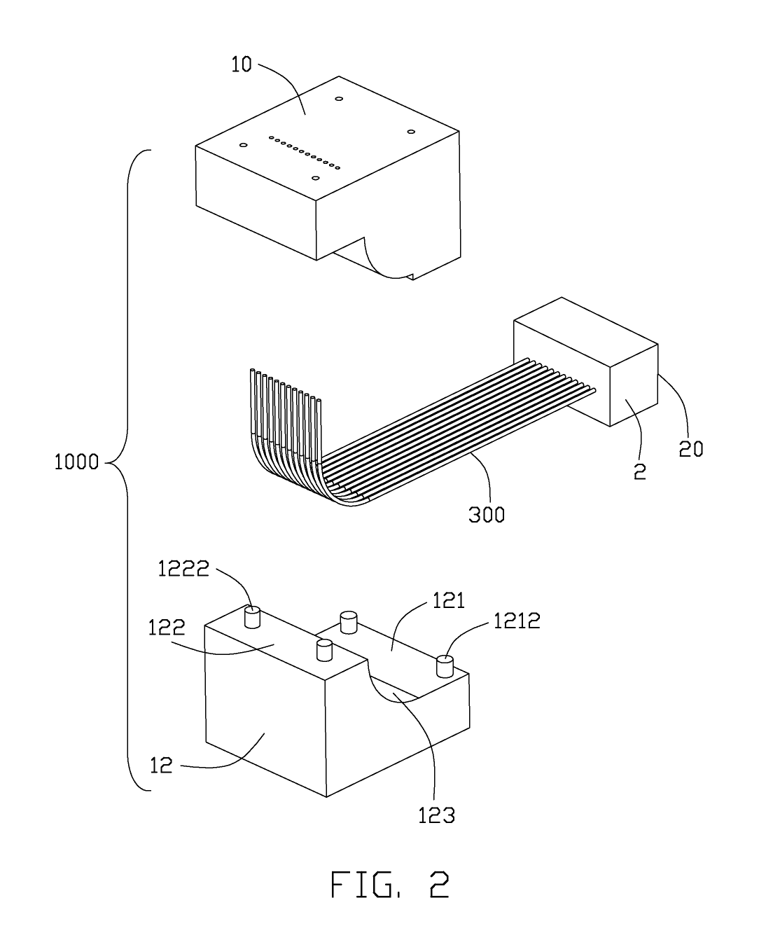

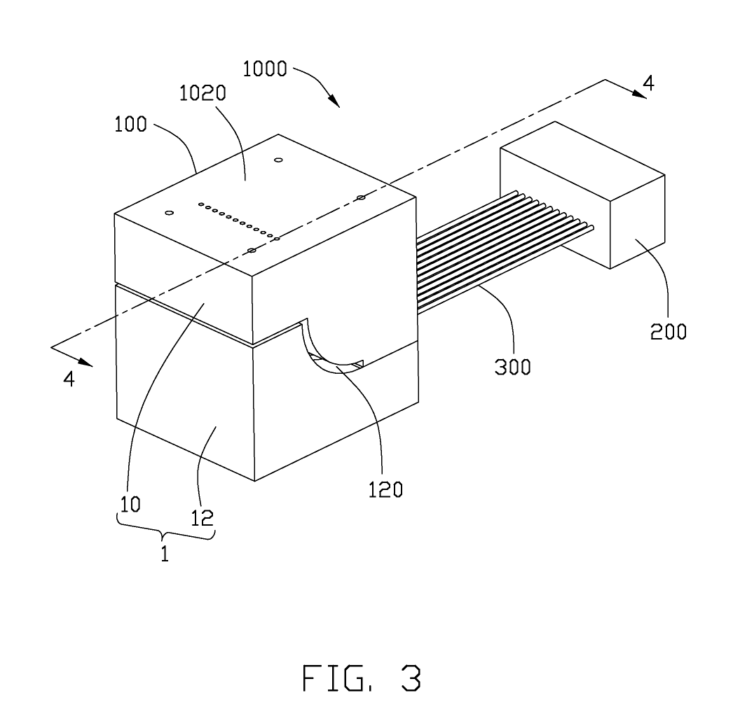

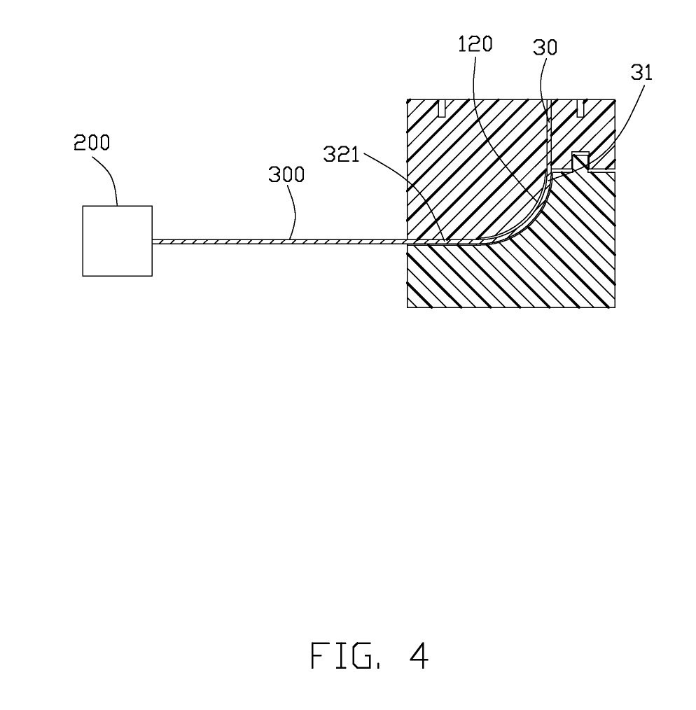

Referring to FIGS. 1-4, a fiber assembly 1000 in accordance with the present invention comprises a first termination (first connector) 100, a second termination (second connector) 200 and a plurality of fibers 300 connecting the first termination 100 and the second termination 200.

The first termination 100 has a first housing 1 which includes a first housing piece 10 and a second housing piece 12 cooperating with the first housing piece 10.

The first housing piece 10 includes a first base portion 101, a first tongue portion 102 and a convex portion 103 between the first base portion 101 and the first tongue portion 102. The first base portion 101 extends along a up-to-down direction and the first tongue portion 102 extends along a front-to-back direction, therefore the first base portion 101 and the first tongue portion 102 are perpendicular to each other. The convex portion 103 has a quarter of cylindrical structure. There are two mounting holes 1012 recessed downwardly from lateral sides of the first base portion 101. A group of positioning grooves 1011 are located in a top side of the first base portion 101. Each positioning groove 1011 extends along the front-to-back direction and opens upward. The positioning grooves 1011 are arranged in a row and separated from each other along a transversal direction. There are a plurality of through holes 1021 located in the first tongue portion 102. The through holes 1021 extend along the up-to-down direction. The through holes 1021 are arranged in a row along the transversal direction. The through holes 1021 are disposed adjacent to a lower edge or a foot of the convex portion 103. There are also two other mounting holes 1022 located in the first tongue portion 102 and disposed in front of the through holes 1021. An upper edge of the convex portion 103 is below a top surface of the first base portion 101, but adjacent to bottom surfaces of positioning grooves 1011.

The second housing piece 12 includes a second base portion 121, a second tongue portion 122 and a concave portion 123 between the second base portion 121 and a second tongue portion 122. The second base portion 121 extends along the front-to-back direction and the second tongue portion 122 extends along the up-to-down direction, therefore the second base portion 121 and the second tongue portion 122 are perpendicular to each other. The concave portion 123 substantially matches with the convex portion 103. There are two positioning posts 1212 formed on lateral sides of the second base portion 121. Also, there are two other posts 1222 formed on the second tongue portion 122.

Each fiber 300 includes a longer horizontal section 32 extending along the front-to-back direction, a shorter vertical section 30 extending along the up-to-down direction and an arc shape mediate section 31 connecting with the horizontal section 32 and the vertical section 30.

The fiber 300 is assembled to the first housing piece 10, with the vertical section 30 inserted into the corresponding through hole 1021, and lower end of the vertical section 30 being polished and substantially flushing with a bottom surface 1020 of the first tongue portion 102 so as to form a first mating interface, a front part 321 of the horizontal section 32 accommodated in the corresponding positioning grooves 1011, and the mediate section 31 extending along the convex portion 103. The second housing piece 12 is mounted to the first housing piece 10 along the up-to-down direction, the first tongue portion 102 abuts against the second tongue portion 122, the first base portion 101 abuts against the second base portion 121, the convex 103 extending or protruding into the concave 123 to together form an arc shape positioning passage 120 therebetween to accommodate and prohibit the mediate section 31, therefore the arc shape mediate sections 31 are confined in the positioning passage 120 and unable to restore to straight state. The positioning passage 120 is an arc shape with about ninety degree central angle. The positioning posts 1212, 1222 are inserted into the mounting holes 1012, 1022, therefore to keep the first housing piece 11 and the second housing piece 12 together.

The second termination 200 has a one-piece second housing 2 combined with a back part 322 of the horizontal section 32. A back end of the back part 322 is polished and substantially flushing with a back surface 20 of the second housing 2 so as to form a second mating interface.

Optical signal (light) enters the horizontal section 32 via the second mating interface of the second termination 200 and runs along the front-to-back direction, then changes transmitting direction after through the mediate section 31, and continues running in the vertical section 30 along the up-to-down direction, and passes though the first mating interface of the first termination 100 at last.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A fiber assembly, comprising:
at least one fiber including a horizontal section extending along a front-to-back direction, a vertical section extending along an up-to-down direction and a mediate section connecting with the horizontal section and the vertical section;
a housing including a first housing piece and a second housing piece combined together to form a substantial ninety degrees arc shape positioning passage therebetween to receive the mediate section, under the condition that the horizontal section and the vertical section are disposed perpendicular to each other.

2. The fiber assembly as recited in claim 1, wherein the first housing piece defines a convex portion and the second housing defines a concave portion, and the convex portion extends into the concave portion to together form the positioning passage.

3. The connector assembly as recited in claim 2, wherein the convex portion has a quarter of cylindrical structure.

4. The connector assembly as recited in claim 2, wherein the first housing piece includes a first base portion, a first tongue portion, and the convex portion is located between the first base portion and the first tongue portion.

5. The connector assembly as recited in claim 4, wherein the first base portion extends along a up-to-down direction and the first tongue portion extends along a front-to-back direction.

6. The connector assembly as recited in claim 5, wherein there is a corresponding positioning groove located in a top side of the first base portion to accommodate the horizontal section of the fiber.

7. The connector assembly as recited in claim 6, wherein the positioning groove opens upwardly and extends along the front-to-back direction.

8. The connector assembly as recited in claim 5, wherein there is a corresponding through hole located in the first tongue portion to receive the vertical section of the fiber.

9. The connector assembly as recited in claim 8, wherein there the through hole extends along the up-to-down direction.

10. The connector assembly as recited in claim 4, wherein the second housing piece includes a second base portion, a second tongue portion, and the concave portion is located between the second base portion and the second tongue portion.

11. The connector assembly as recited in claim 10, wherein the second base portion extends along the front-to-back direction and the second tongue portion extends along the up-to-down direction.

12. A fiber assembly, comprising:
a plurality of fibers including horizontal sections extending along a front-to-back direction, vertical sections extending along an up-to-down direction and arc shape mediate sections connecting with the horizontal sections and the vertical sections;
a first housing including a first housing piece and a second housing piece assembled together to prohibiting the arc shape mediate sections restoring to straight state; and a plurality of through holes defined in at least one of the housing pieces to respectively receive the vertical sections, with lower ends of the vertical sections substantially flushing with a bottom surface of the corresponding housing piece so as to form a first mating interface; and
a second housing combined with back parts of the horizontal sections of the fibers, with back ends of the back parts substantially flushing with a back surface of the second housing so as to form a second mating interface.

13. The fiber assembly as recited in claim 12, wherein the first housing piece and the second housing piece together defines an arc shape positioning passage to accommodate and prohibit the mediate sections of the fibers.

14. The fiber assembly as recited in claim 13, wherein the first housing piece defines a convex portion and the second housing defines a concave portion, and the positioning passage is formed by the convex portion and the concave portion.

15. The fiber assembly as recited in claim 12, wherein the second housing is one-piece structure.

16. The fiber assembly as recited in claim 12, wherein the first mating interface opens along the vertical direction, and the second mating interface opens along the horizontal direction perpendicular to the vertical direction.

17. A fiber assembly comprising:
a connector including:
a first housing piece defining a first exterior face for coupling and a second exterior face for extension, a plurality of first through holes extending through the first exterior face;
a second housing piece assembled with the first housing piece with an interface structure formed therebetween;
a plurality of grooves formed in at least one of said first housing piece and said second housing piece around the interface structure and extending through the second exterior face; and
a plurality of optic fibers each having a first section extending in the corresponding through hole and a second section extending in the corresponding groove; wherein said interface structure defines a curved configuration between the through holes and the grooves for supportably guiding bending of the corresponding optical fibers.

18. The fiber assembly as claimed in claim 17, wherein the optic fibers in the curved configuration are looser than in the through holes and the grooves.

19. The fiber assembly as claimed in claim 17, wherein the optic fibers extend out of the second exterior face and connect to another connector.

20. The fiber assembly as claimed in claim 17, wherein the first exterior face is perpendicular to the second exterior face, and the through holes are perpendicular to the grooves.
